(19) United States
(12) Patent Application Publication
(10) Pub. No.: US 2020/0300079 A1
(43) Pub. Date: Sep. 24, 2020

(54) MONITORING A RIG TUBULAR HANDLING SYSTEM

(71) Applicant: Schlumberger Technology Corporation, Sugar Land, TX (US)

(72) Inventor: Alejandro Camacho Cardenas, Houston, TX (US)

(21) Appl. No.: 16/788,970

(22) Filed: Feb. 12, 2020

Related U.S. Application Data
(60) Provisional application No. 62/804,542, filed on Feb. 12, 2019.

(51) Int. Cl. E21B 47/06; E21B 47/10; G05B 15/02

(52) U.S. Cl. CPC E21B 47/06; G05B 15/02; E21B 47/10

(57) ABSTRACT

A method for monitoring a component includes measuring a first parameter of the component of a tubular handling system using a sensor. The component moves as the tubular handling system moves a tubular. The first parameter is related to movement of the component. The method also includes determining a second parameter of the component based at least partially upon the first parameter. The method also includes determining whether the second parameter is within an operating limit.

### BACKGROUND

Wellsites oftentimes include a plurality of tubulars segments, such as drill string segments, casing segments, and the like. The tubular segments may be coupled together to form a string that may be run into a wellbore. Tubular handling equipment is used to couple the tubular segments together, decouple the tubular segments from one another, place the tubular segments during times of non-use, etc. The tubular handling equipment may be automated to increase performance, reduce human activity, and improve consistency. Automated tubular handling includes complex mechanical and control systems with a multitude of sensors and moving parts. The ability to track the performance and health of these systems may prevent downtime and maintain performance at the desired levels.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A method for monitoring a component is disclosed. The method includes measuring a first parameter of the component of a tubular handling system using a sensor. The component moves as the tubular handling system moves a tubular. The first parameter is related to movement of the component. The method also includes determining a second parameter of the component based at least partially upon the first parameter. The method also includes determining whether the second parameter is within an operating limit.

In another embodiment, the method includes measuring a first parameter of the component using a sensor. The first parameter is measured during a first actuation of the component that occurs at a first time or during a first time duration, and during a second actuation of the component that occurs at a second time or during a second time duration. The first time or the first time duration occurs before the second time or the second time duration. The method also includes determining a second parameter of the component based at least partially upon the first parameter. The second parameter is determined during the first actuation and the second actuation. The method also includes comparing the second parameter during the first actuation with the second parameter during the second actuation.

A tubular handling system is also disclosed. The system includes a component and a sensor configured to measure a position of the component during a first actuation of the component and during a second actuation of the component. The first actuation occurs at a first time or during a first time duration. The second actuation occurs at a second time or during a second time duration. A control system is configured to receive the position of the component during the first actuation and the second actuation, determine a velocity of the component based at least partially upon the position during the first actuation and the second actuation, determine an acceleration of the component based at least partially upon the velocity during the first actuation and the second actuation, determine whether the position, the velocity, and the acceleration are within operating limits during the first actuation and the second actuation, and determine whether a health, a performance, or both of the component have decreased from the first actuation to the second actuation based at least partially upon the position, the velocity, the acceleration, or a combination thereof.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a conceptual, schematic view of a control system for a drilling rig, according to an embodiment.

FIG. 2 illustrates a conceptual, schematic view of the control system, according to an embodiment.

FIG. 3 illustrates a perspective view of a tubular handling system, according to an embodiment.

FIG. 4 illustrates a perspective view of a portion of the tubular handling system (e.g., a standbuilding system), according to an embodiment.

FIG. 5 illustrates a perspective view of a portion of the tubular handling system (e.g., a vertical racking system), according to an embodiment.

FIG. 6 illustrates a perspective view of a portion of the tubular handling system (e.g., a tubular connection system), according to an embodiment.

FIG. 7 illustrates a perspective view of a portion of the tubular handling system (e.g., a catwalk machine), according to an embodiment.

FIG. 8 illustrates a flowchart of a method for monitoring health and/or performance of the tubular handling system, according to an embodiment.

FIG. 9 illustrates a graph showing position, velocity, and acceleration of the component of the tubular handling system, according to an embodiment.

FIG. 10 illustrates another graph showing position, velocity, and acceleration of the component of the tubular handling system, according to an embodiment.

FIG. 11 illustrates a computing system for performing at least a portion of the method, according to an embodiment.

### DETAILED DESCRIPTION

Reference will now be made in detail to specific embodiments illustrated in the accompanying drawings and figures. In the following detailed description, numerous specific details are set forth in order to provide a thorough understanding of the invention. However, it will be apparent to one of ordinary skill in the art that embodiments may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object or step, and, similarly, a second object could be termed a first object or step, without departing from the scope of the present disclosure.

The terminology used in the description of the invention herein is for the purpose of describing particular embodiments only and is not intended to be limiting. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items.

It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

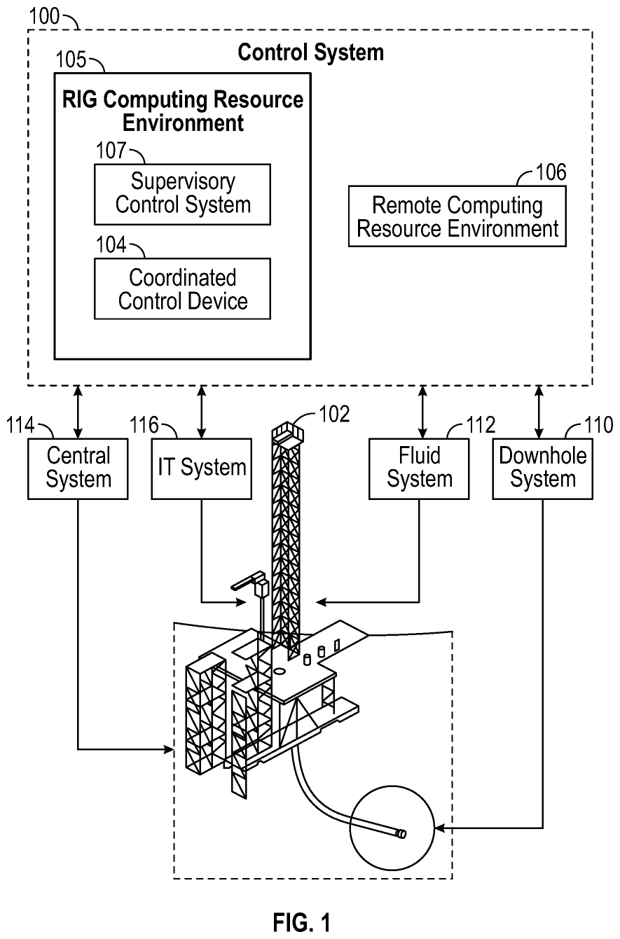

FIG. 1 illustrates a conceptual, schematic view of a control system 100 for a drilling rig 102, according to an embodiment. The control system 100 may include a rig computing resource environment 105, which may be located onsite at the drilling rig 102 and, in some embodiments, may have a coordinated control device 104. The control system 100 may also provide a supervisory control system 107. In some embodiments, the control system 100 may include a remote computing resource environment 106, which may be located offsite from the drilling rig 102.

The remote computing resource environment 106 may include computing resources locating offsite from the drilling rig 102 and accessible over a network. A “cloud” computing environment is one example of a remote computing resource. The cloud computing environment may communicate with the rig computing resource environment 105 via a network connection (e.g., a WAN or LAN connection). In some embodiments, the remote computing resource environment 106 may be at least partially located onsite, e.g., allowing control of various aspects of the drilling rig 102 onsite through the remote computing resource environment 105 (e.g., via mobile devices). Accordingly, “remote” should not be limited to any particular distance away from the drilling rig 102.

Further, the drilling rig 102 may include various systems with different sensors and equipment for performing operations of the drilling rig 102, and may be monitored and controlled via the control system 100, e.g., the rig computing resource environment 105. Additionally, the rig computing resource environment 105 may provide for secured access to rig data to facilitate onsite and offsite user devices monitoring the rig, sending control processes to the rig, and the like.

Various example systems of the drilling rig 102 are depicted in FIG. 1. For example, the drilling rig 102 may include a downhole system 110, a fluid system 112, and a central system 114. These systems 110, 112, 114 may also be examples of “subsystems” of the drilling rig 102, as described herein. In some embodiments, the drilling rig 102 may include an information technology (IT) system 116. The downhole system 110 may include, for example, a bottomhole assembly (BHA), mud motors, sensors, etc. disposed along the drill string, and/or other drilling equipment configured to be deployed into the wellbore. Accordingly, the downhole system 110 may refer to tools disposed in the wellbore, e.g., as part of the drill string used to drill the well.

The fluid system 112 may include, for example, drilling mud, pumps, valves, cement, mud-loading equipment, mud-management equipment, pressure-management equipment, separators, and other fluids equipment. Accordingly, the fluid system 112 may perform fluid operations of the drilling rig 102.

The central system 114 may include a hoisting and rotating platform, top drives, rotary tables, kellys, drawworks, pumps, generators, tubular handling equipment, derricks, masts, substructures, and other suitable equipment. Accordingly, the central system 114 may perform power generation, hoisting, and rotating operations of the drilling rig 102, and serve as a support platform for drilling equipment and staging ground for rig operation, such as connection make up, etc. The IT system 116 may include software, computers, and other IT equipment for implementing IT operations of the drilling rig 102.

The control system 100, e.g., via the coordinated control device 104 of the rig computing resource environment 105, may monitor sensors from multiple systems of the drilling rig 102 and provide control commands to multiple systems of the drilling rig 102, such that sensor data from multiple systems may be used to provide control commands to the different systems of the drilling rig 102. For example, the system 100 may collect temporally and depth aligned surface data and downhole data from the drilling rig 102 and store the collected data for access onsite at the drilling rig 102 or offsite via the rig computing resource environment 105. Thus, the system 100 may provide monitoring capability. Additionally, the control system 100 may include supervisory control via the supervisory control system 107.

In some embodiments, one or more of the downhole system 110, fluid system 112, and/or central system 114 may be manufactured and/or operated by different vendors. In such an embodiment, certain systems may not be capable of unified control (e.g., due to different protocols, restrictions on control permissions, safety concerns for different control systems, etc.). An embodiment of the control system 100 that is unified, may, however, provide control over the drilling rig 102 and its related systems (e.g., the downhole system 110, fluid system 112, and/or central system 114, etc.). Further, the downhole system 110 may include one or a plurality of downhole systems. Likewise, fluid system 112, and central system 114 may contain one or a plurality of fluid systems and central systems, respectively.

In addition, the coordinated control device 104 may interact with the user device(s) (e.g., human-machine interface(s)) 118, 120. For example, the coordinated control device 104 may receive commands from the user devices 118, 120 and may execute the commands using two or more of the rig systems 110, 112, 114, e.g., such that the operation of the two or more rig systems 110, 112, 114 act in concert and/or off-design conditions in the rig systems 110, 112, 114 may be avoided.

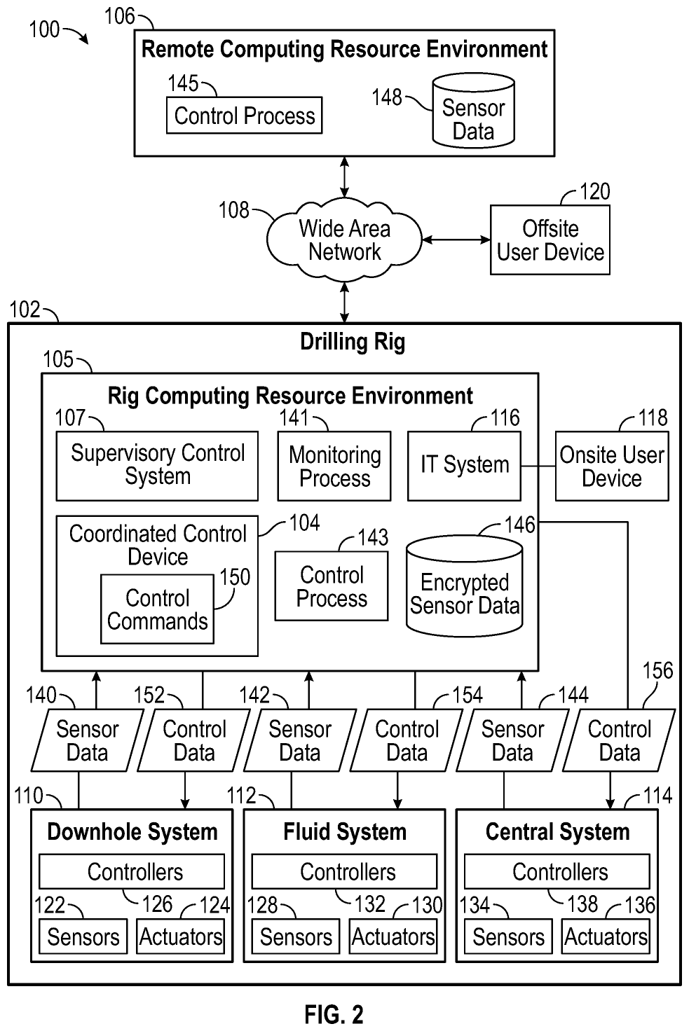

FIG. 2 illustrates a conceptual, schematic view of the control system 100, according to an embodiment. The rig computing resource environment 105 may communicate with offsite devices and systems using a network 108 (e.g., a wide area network (WAN) such as the internet). Further, the rig computing resource environment 105 may communicate with the remote computing resource environment 106 via the network 108. FIG. 2 also depicts the aforementioned example systems of the drilling rig 102, such as the downhole system 110, the fluid system 112, the central system 114, and the IT system 116. In some embodiments, one or more onsite user devices 118 may also be included on the drilling rig 102. The onsite user devices 118 may interact with the IT system 116. The onsite user devices 118 may include any number of user devices, for example, stationary user devices intended to be stationed at the drilling rig 102 and/or portable user devices. In some embodiments, the onsite user devices 118 may include a desktop, a laptop, a smartphone, a personal data assistant (PDA), a tablet component, a wearable computer, or other suitable devices. In some embodiments, the onsite user devices 118 may communicate with the rig computing resource environment 105 of the drilling rig 102, the remote computing resource environment 106, or both.

One or more offsite user devices 120 may also be included in the system 100. The offsite user devices 120 may include a desktop, a laptop, a smartphone, a personal data assistant (PDA), a tablet component, a wearable computer, or other suitable devices. The offsite user devices 120 may be configured to receive and/or transmit information (e.g., monitoring functionality) from and/or to the drilling rig 102 via communication with the rig computing resource environment 105. In some embodiments, the offsite user devices 120 may provide control processes for controlling operation of the various systems of the drilling rig 102. In some embodiments, the offsite user devices 120 may communicate with the remote computing resource environment 106 via the network 108.

The user devices 118 and/or 120 may be examples of a human-machine interface. These devices 118, 120 may allow feedback from the various rig subsystems to be displayed and allow commands to be entered by the user. In various embodiments, such human-machine interfaces may be onsite or offsite, or both.

The systems of the drilling rig 102 may include various sensors, actuators, and controllers (e.g., programmable logic controllers (PLCs)), which may provide feedback for use in the rig computing resource environment 105. For example, the downhole system 110 may include sensors 122, actuators 124, and controllers 126. The fluid system 112 may include sensors 128, actuators 130, and controllers 132. Additionally, the central system 114 may include sensors 134, actuators 136, and controllers 138. The sensors 122, 128, and 134 may include any suitable sensors for operation of the drilling rig 102. In some embodiments, the sensors 122, 128, and 134 may include a camera, a pressure sensor, a temperature sensor, a flow rate sensor, a vibration sensor, a current sensor, a voltage sensor, a resistance sensor, a gesture detection sensor or device, a voice actuated or recognition device or sensor, or other suitable sensors.

The sensors described above may provide sensor data feedback to the rig computing resource environment 105 (e.g., to the coordinated control device 104). For example, downhole system sensors 122 may provide sensor data 140, the fluid system sensors 128 may provide sensor data 142, and the central system sensors 134 may provide sensor data 144. The sensor data 140, 142, and 144 may include, for example, equipment operation status (e.g., on or off, up or down, set or release, etc.), drilling parameters (e.g., depth, hook load, torque, etc.), auxiliary parameters (e.g., vibration data of a pump) and other suitable data. In some embodiments, the acquired sensor data may include or be associated with a timestamp (e.g., a date, time or both) indicating when the sensor data was acquired. Further, the sensor data may be aligned with a depth or other drilling parameter.

Acquiring the sensor data into the coordinated control device 104 may facilitate measurement of the same physical properties at different locations of the drilling rig 102. In some embodiments, measurement of the same physical properties may be used for measurement redundancy to enable continued operation of the well. In yet another embodiment, measurements of the same physical properties at different locations may be used for detecting equipment conditions among different physical locations. In yet another embodiment, measurements of the same physical properties using different sensors may provide information about the relative quality of each measurement, resulting in a “higher” quality measurement being used for rig control, and process applications. The variation in measurements at different locations over time may be used to determine equipment performance, system performance, scheduled maintenance due dates, and the like. Furthermore, aggregating sensor data from each subsystem into a centralized environment may enhance drilling process and efficiency. For example, slip status (e.g., in or out) may be acquired from the sensors and provided to the rig computing resource environment 105, which may be used to define a rig state for automated control. In another example, acquisition of fluid samples may be measured by a sensor and related with bit depth and time measured by other sensors. Acquisition of data from a camera sensor may facilitate detection of arrival and/or installation of materials or equipment in the drilling rig 102. The time of arrival and/or installation of materials or equipment may be used to evaluate degradation of a material, scheduled maintenance of equipment, and other evaluations.

The coordinated control device 104 may facilitate control of individual systems (e.g., the central system 114, the downhole system, or fluid system 112, etc.) at the level of each individual system. For example, in the fluid system 112, sensor data 128 may be fed into the controller 132, which may respond to control the actuators 130. However, for control operations that involve multiple systems, the control may be coordinated through the coordinated control device 104. Examples of such coordinated control operations include the control of downhole pressure during tripping. The downhole pressure may be affected by both the fluid system 112 (e.g., pump rate and choke position) and the central system 114 (e.g. tripping speed). When it is desired to maintain certain downhole pressure during tripping, the coordinated control device 104 may be used to direct the appropriate control commands. Furthermore, for mode based controllers which employ complex computation to reach a control setpoint, which are typically not implemented in the subsystem PLC controllers due to complexity and high computing power demands, the coordinated control device 104 may provide the adequate computing environment for implementing these controllers.

In some embodiments, control of the various systems of the drilling rig 102 may be provided via a multi-tier (e.g., three-tier) control system that includes a first tier of the controllers 126, 132, and 138, a second tier of the coordinated control device 104, and a third tier of the supervisory control system 107. The first tier of the controllers may be responsible for safety critical control operation, or fast loop feedback control. The second tier of the controllers may be responsible for coordinated controls of multiple equipment or subsystems, and/or responsible for complex model based controllers. The third tier of the controllers may be responsible for high level task planning, such as to command the rig system to maintain certain bottom hole pressure. In other embodiments, coordinated control may be provided by one or more controllers of one or more of the drilling rig systems 110, 112, and 114 without the use of a coordinated control device 104. In such embodiments, the rig computing resource environment 105 may provide control processes directly to these controllers for coordinated control. For example, in some embodiments, the controllers 126 and the controllers 132 may be used for coordinated control of multiple systems of the drilling rig 102.

The sensor data 140, 142, and 144 may be received by the coordinated control device 104 and used for control of the drilling rig 102 and the drilling rig systems 110, 112, and 114. In some embodiments, the sensor data 140, 142, and 144 may be encrypted to produce encrypted sensor data 146. For example, in some embodiments, the rig computing resource environment 105 may encrypt sensor data from different types of sensors and systems to produce a set of encrypted sensor data 146. Thus, the encrypted sensor data 146 may not be viewable by unauthorized user devices (either offsite or onsite user device) if such devices gain access to one or more networks of the drilling rig 102. The sensor data 140, 142, 144 may include a timestamp and an aligned drilling parameter (e.g., depth) as discussed above. The encrypted sensor data 146 may be sent to the remote computing resource environment 106 via the network 108 and stored as encrypted sensor data 148.

The rig computing resource environment 105 may provide the encrypted sensor data 148 available for viewing and processing offsite, such as via offsite user devices 120. Access to the encrypted sensor data 148 may be restricted via access control implemented in the rig computing resource environment 105. In some embodiments, the encrypted sensor data 148 may be provided in real-time to offsite user devices 120 such that offsite personnel may view real-time status of the drilling rig 102 and provide feedback based on the real-time sensor data. For example, different portions of the encrypted sensor data 146 may be sent to offsite user devices 120. In some embodiments, encrypted sensor data may be decrypted by the rig computing resource environment 105 before transmission or decrypted on an offsite user device after encrypted sensor data is received.

The offsite user device 120 may include a client (e.g., a thin client) configured to display data received from the rig computing resource environment 105 and/or the remote computing resource environment 106. For example, multiple types of thin clients (e.g., devices with display capability and minimal processing capability) may be used for certain functions or for viewing various sensor data.

The rig computing resource environment 105 may include various computing resources used for monitoring and controlling operations such as one or more computers having a processor and a memory. For example, the coordinated control device 104 may include a computer having a processor and memory for processing sensor data, storing sensor data, and issuing control commands responsive to sensor data. As noted above, the coordinated control device 104 may control various operations of the various systems of the drilling rig 102 via analysis of sensor data from one or more drilling rig systems (e.g. 110, 112, 114) to enable coordinated control between each system of the drilling rig 102. The coordinated control device 104 may execute control commands 150 for control of the various systems of the drilling rig 102 (e.g., drilling rig systems 110, 112, 114). The coordinated control device 104 may send control data determined by the execution of the control commands 150 to one or more systems of the drilling rig 102. For example, control data 152 may be sent to the downhole system 110, control data 154 may be sent to the fluid system 112, and control data 154 may be sent to the central system 114. The control data may include, for example, operator commands (e.g., turn on or off a pump, switch on or off a valve, update a physical property setpoint, etc.). In some embodiments, the coordinated control device 104 may include a fast control loop that directly obtains sensor data 140, 142, and 144 and executes, for example, a control algorithm. In some embodiments, the coordinated control device 104 may include a slow control loop that obtains data via the rig computing resource environment 105 to generate control commands.

In some embodiments, the coordinated control device 104 may intermediate between the supervisory control system 107 and the controllers 126, 132, and 138 of the systems 110, 112, and 114. For example, in such embodiments, a supervisory control system 107 may be used to control systems of the drilling rig 102. The supervisory control system 107 may include, for example, devices for entering control commands to perform operations of systems of the drilling rig 102. In some embodiments, the coordinated control device 104 may receive commands from the supervisory control system 107, process the commands according to a rule (e.g., an algorithm based upon the laws of physics for drilling operations), and/or control processes received from the rig computing resource environment 105, and provides control data to one or more systems of the drilling rig 102. In some embodiments, the supervisory control system 107 may be provided by and/or controlled by a third party. In such embodiments, the coordinated control device 104 may coordinate control between discrete supervisory control systems and the systems 110, 112, and 114 while using control commands that may be optimized from the sensor data received from the systems 110 112, and 114 and analyzed via the rig computing resource environment 105.

The rig computing resource environment 105 may include a monitoring process 141 that may use sensor data to determine information about the drilling rig 102. For example, in some embodiments the monitoring process 141 may determine a drilling state, equipment health, system health, a maintenance schedule, or any combination thereof. Furthermore, the monitoring process 141 may monitor sensor data and determine the quality of one or a plurality of sensor data. In some embodiments, the rig computing resource environment 105 may include control processes 143 that may use the sensor data 146 to optimize drilling operations, such as, for example, the control of drilling equipment to improve drilling efficiency, equipment reliability, and the like. For example, in some embodiments the acquired sensor data may be used to derive a noise cancellation scheme to improve electromagnetic and mud pulse telemetry signal processing. The control processes 143 may be implemented via, for example, a control algorithm, a computer program, firmware, or other suitable hardware and/or software. In some embodiments, the remote computing resource environment 106 may include a control process 145 that may be provided to the rig computing resource environment 105.

The rig computing resource environment 105 may include various computing resources, such as, for example, a single computer or multiple computers. In some embodiments, the rig computing resource environment 105 may include a virtual computer system and a virtual database or other virtual structure for collected data. The virtual computer system and virtual database may include one or more resource interfaces (e.g., web interfaces) that enable the submission of application programming interface (API) calls to the various resources through a request. In addition, each of the resources may include one or more resource interfaces that enable the resources to access each other (e.g., to enable a virtual computer system of the computing resource environment to store data in or retrieve data from the database or other structure for collected data).

The virtual computer system may include a collection of computing resources configured to instantiate virtual machine instances. The virtual computing system and/or computers may provide a human-machine interface through which a user may interface with the virtual computer system via the offsite user device or, in some embodiments, the onsite user device. In some embodiments, other computer systems or computer system services may be utilized in the rig computing resource environment 105, such as a computer system or computer system service that provisions computing resources on dedicated or shared computers/servers and/or other physical devices. In some embodiments, the rig computing resource environment 105 may include a single server (in a discrete hardware component or as a virtual server) or multiple servers (e.g., web servers, application servers, or other servers). The servers may be, for example, computers arranged in any physical and/or virtual configuration

In some embodiments, the rig computing resource environment 105 may include a database that may be a collection of computing resources that run one or more data collections. Such data collections may be operated and managed by utilizing API calls. The data collections, such as sensor data, may be made available to other resources in the rig computing resource environment or to user devices (e.g., onsite user device 118 and/or offsite user device 120) accessing the rig computing resource environment 105. In some embodiments, the remote computing resource environment 106 may include similar computing resources to those described above, such as a single computer or multiple computers (in discrete hardware components or virtual computer systems).

The systems and methods disclosed herein track and monitor performance and health of a rig's tubular handling system (THS). The systems and methods may utilize sensor data and corresponding time-stamps to measure and/or determine the position, speed, acceleration, and/or force/loading of a component during one or more rig sequences. Reaction times, performance, health indexes, and degradation may be determined based at least partially upon these measurements/determinations. In response, an alarm may be triggered and/or a maintenance activity may be initiated, to ensure that the rig's tubular handling system operates within equipment limits.

The tubular handling system may include one or more mechanical systems that perform movement and grabbing functions. The mechanical systems may include arms, joints, and actuators. The control system 100, such as the one described above with regard to FIGS. 1 and 2, is utilized to execute the commands to synchronize movements in the sequence to perform a given activity. Feedback to the control system 100 is given by sensors (e.g., sensors 122, 128, 134) located at multiple locations within the THS.

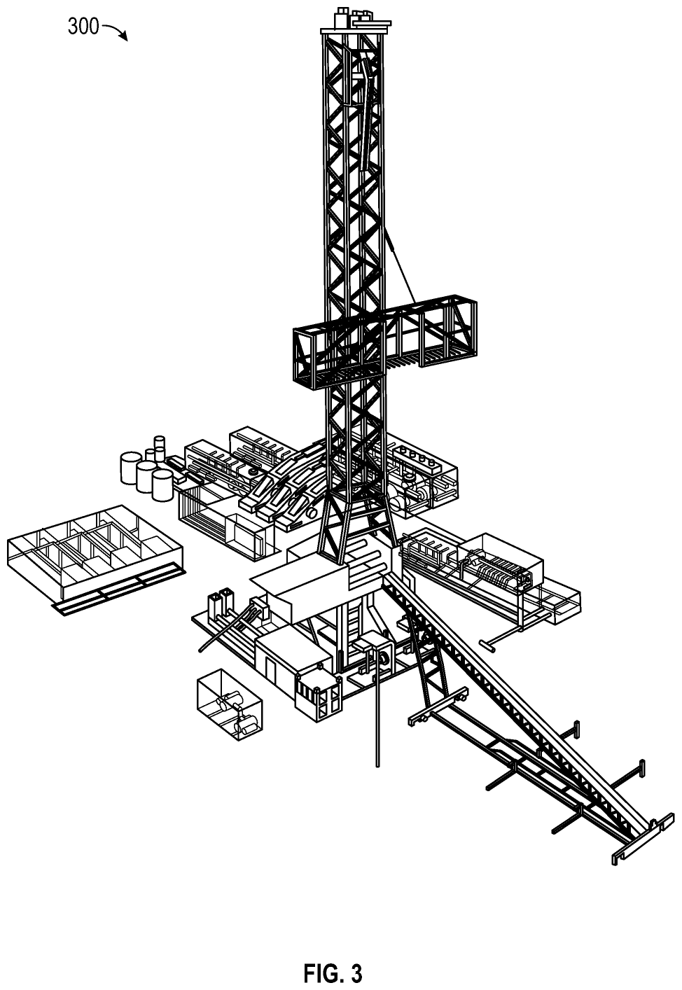

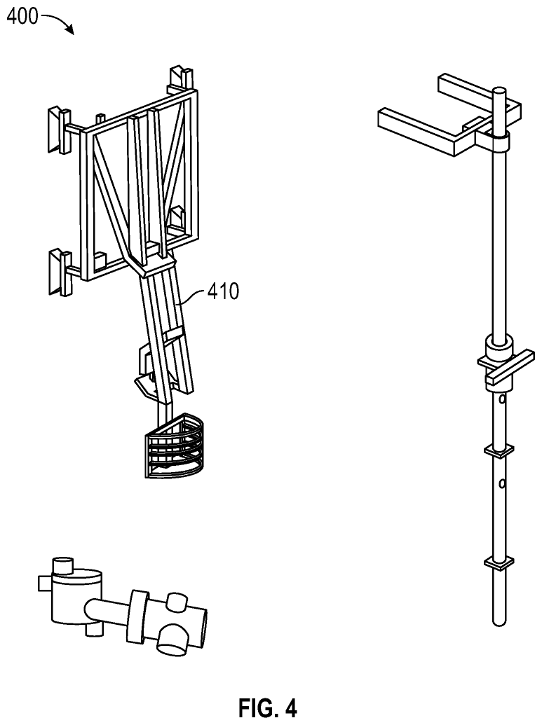

FIG. 3 illustrates a perspective view of a tubular handling system 300, according to an embodiment. The tubular handling system 300 may include a standbuilding system, a vertical racking system, a tubular connection system, and a catwalk machine, which are shown in greater in FIGS. 4-8 and described below. As will be appreciated, this is merely one example of a tubular handling system 300, and other tubular handling systems may include different components.

FIG. 4 illustrates a perspective view of a portion of the tubular handling system (e.g., the standbuilding system 400), according to an embodiment. The standbuilding system 400 includes one or more (e.g., upper and lower) robotic arms 410 that grab and move pipe to/from the catwalk, rack, and well. More particularly, the arms 410 may locate, grab, move, release, etc. the pipe. The arms 410 have sub-components that also actuate. The pipe may be or include segments of drill pipe, casing, etc.

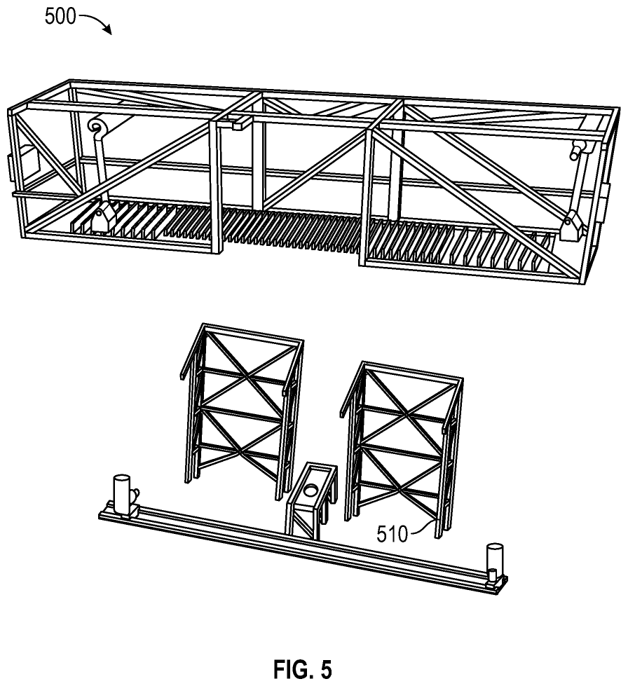

FIG. 5 illustrates a perspective view of a portion of the tubular handling system (e.g., the vertical racking system 500), according to an embodiment. The vertical racking system 500 includes one or more devices 510 that hold and store pipe vertically.

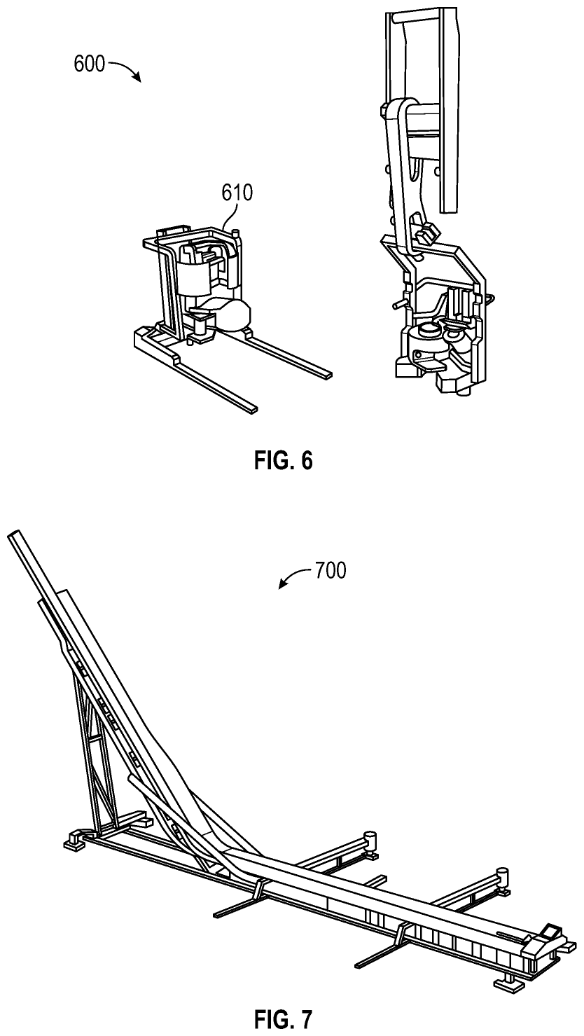

FIG. 6 illustrates a perspective view of a portion of the tubular handling system (e.g., the tubular connection system 600), according to an embodiment. The tubular connection system 600 includes equipment 610 used to connect segments of pipe to one another and disconnect segments of pipe from one another. More particularly, the equipment 610 may move to meet the pipe connection location. The equipment 610 may also adjust its position on the horizontal and vertical planes, and therefore has one or more corresponding degrees of freedom.

FIG. 7 illustrates a perspective view of a portion of the tubular handling system (e.g., the catwalk machine 700), according to an embodiment. The catwalk machine 700 includes a lower section of the pipe handler that can assemble stands of pipe (e.g., two or more segments coupled together) and move them up for the standbuilding system 400 to lift.

With regard to FIGS. 4-7, each moving component may include one or more moving sub-components. Each time a component (e.g., a hydraulic cylinder, a piston, an actuator, etc.) moves, there may be a sensor signature (e.g., pressure, proximity switch, encoder, etc.) that may provide information about (a) the location of the component and/or (b) whether the displacement has been achieved (and therefore information about location). Tracking, monitoring, and processing the signatures over time may be used to derive the health of the component. In general, the different components may be part of or otherwise include arms, grabbers, ramps, platforms, etc.

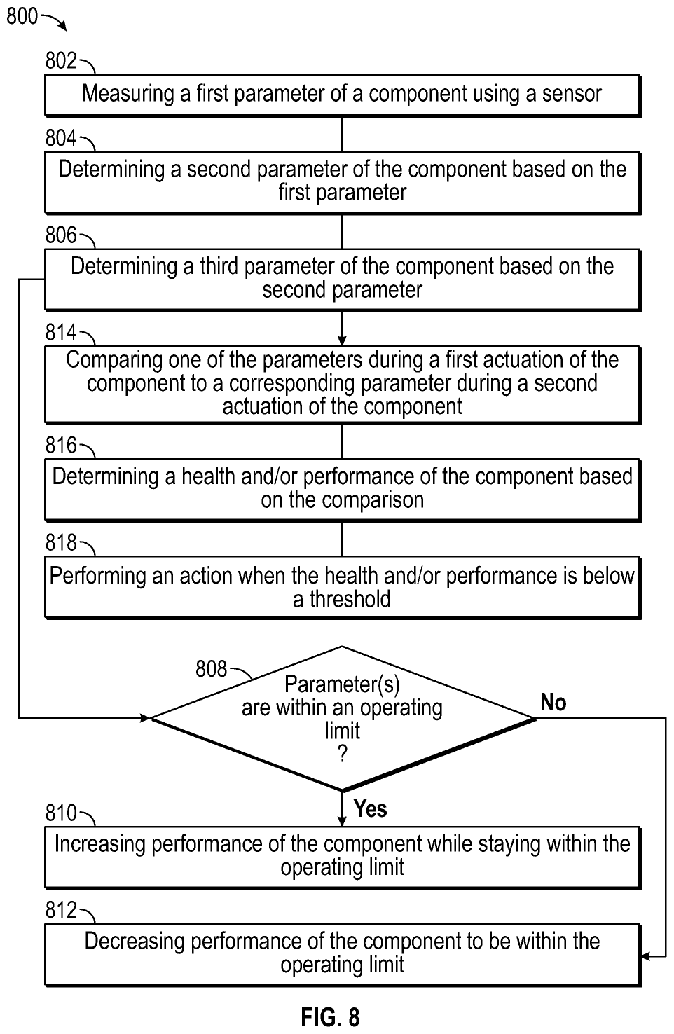

FIG. 8 illustrates a flowchart of a method 800 for monitoring health and/or performance of a system (e.g., the tubular handling system 300), according to an embodiment. At least a portion of the method 800 may be performed by/using the control system 100. The method 800 may include measuring a first parameter of a component of the tubular handling system 300 using one or more sensors, as at 802. In the example below, the first parameter is a position of the component of the tubular handling system 300. This may include the position of the component with respect to a fixed point, another component of the tubular handling system 300, or rig personnel.

In other examples, the first parameter may be or include a velocity and/or an acceleration of the component of the tubular handling system 300. The component may be or include a movable component of the tubular handling system 300 a hydraulic cylinder, a piston, or an actuator. The sensors may be or include one or more of the sensors 122, 128, 134 discussed above, or the sensors may be different. The sensors may be or include encoders or proximity switches. In one embodiment, the sensors may be proximity switches that are located near the starting and/or endpoints of the movement (e.g., proximity switches). These sensors may detect that the component has reached a certain location. In another embodiment, the sensors may be encoders that continuously track the position of the component as part of their operation and control. Therefore, the sensors may contain position information at any given time. These sensors may be normally located as part of the actuating component (e.g., traction motors) and therefore may not be next to the moving component itself. In yet another embodiment, the position information of the component can be derived (calculated) from other measurements (e.g., such as pressure acting on hydraulic cylinders). The sensors may be positioned where the process is monitored (e.g., hydraulic pressure can be monitored in a fitting where the hydraulic power is administered).

The method 800 may also include determining a second parameter of the component based at least partially upon the first parameter, as at 804. In another embodiment, the method 800 may instead include measuring the second parameter using the one or more sensors. In the example below, the second parameter is a velocity of the component of the tubular handling system 300. In other examples, the second parameter may be or include an acceleration of the component or a force on the component. When the first parameter is position, and the second parameter is velocity, the second parameter may be determined as the derivative of the first parameter with respect to time.

The method 800 may also or instead include determining a third parameter of the component based at least partially upon the first parameter and/or the second parameter, as at 806. In another embodiment, the method 800 may instead include measuring the third parameter using the one or more sensors. In the example below, the third parameter is an acceleration of the component of the tubular handling system 300. For example, when the first parameter is position, and the second parameter is velocity, the third parameter may be determined as the second derivative of the first parameter with respect to time, or as the first derivative of the second parameter with respect to time.

In at least one embodiment, the second parameter and/or the third parameter may be both measured (e.g., by the sensors) and determined (e.g., based at least partially upon the measured first parameter). The measured and determined parameter(s) may be compared and used to calibrate the sensors and/or validate the data.

The time differential (dt) is the time difference between two or more different measurements (e.g., of position or velocity). The measurements may be linear, angular, or in any other coordinate system. The position, velocity, and/or acceleration may follow the same coordinate system or be transformed into a different coordinate system. In at least one embodiment, a force/loading of the component may be determined based at least partially upon the position, velocity, and/or acceleration.

The first parameter (e.g., position), the second parameter (e.g., velocity), and/or the third parameter (e.g., acceleration) may be measured (e.g., at 802) and/or determined (e.g., at 804 or 806) at a plurality of different times. The plurality of different times may include at least a first time, a second time that is later than the first time, a third time that is later than the second time, etc. For example, the first parameter may include a plurality of position measurements with associated time stamps (e.g., associated by its sampling and/or reporting rates).

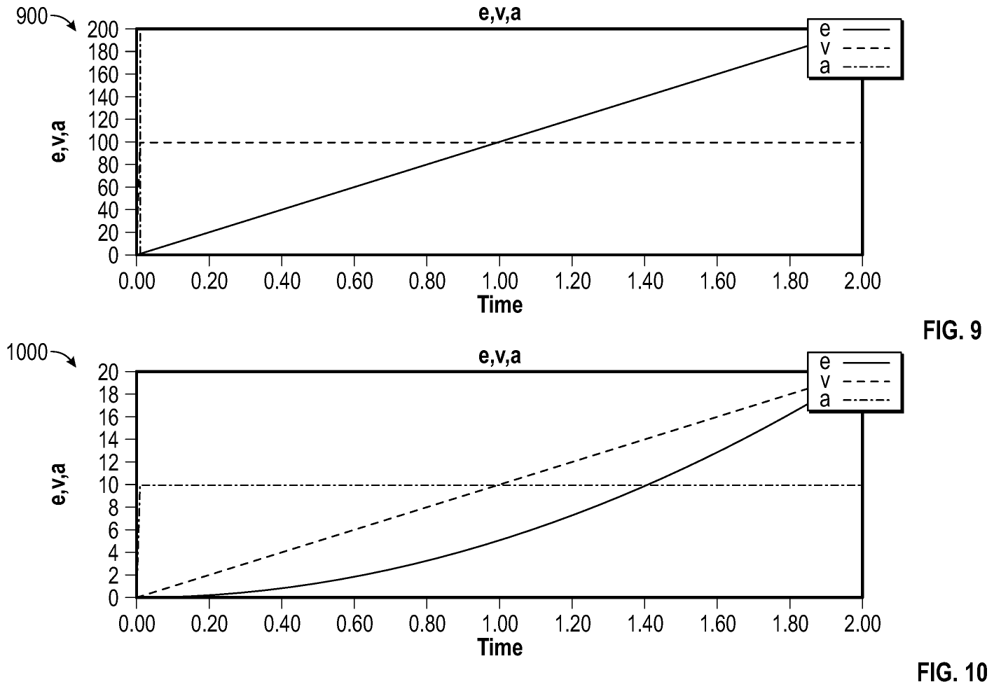

FIG. 9 illustrates a graph 900 showing position, velocity, and acceleration of the component of the tubular handling system 300, according to an embodiment. In the graph 900, the velocity is constant and, thus, the acceleration is zero.

FIG. 10 illustrates another graph 1000 showing position, velocity, and acceleration of the component of the tubular handling system 300, according to an embodiment. In the graph 1000, the velocity is increasing, and the acceleration is constant.

The method 800 may also include determining whether the first parameter, the second parameter, and/or the third parameter is/are within operating limits, as at 808. In one example, this may include comparing the measured first parameter (e.g., position) to a predetermined operating limit for the first parameter. In another example, this may include comparing the measured or determined second parameter (e.g., velocity) to a predetermined operating limit for the second parameter. In yet another example, this may include comparing the measured or determined third parameter (e.g., acceleration) to a predetermined operating limit for the third parameter. The operating limits may be static limits (e.g., set by the operator) or dynamic limits (e.g., based on operational and/or environmental conditions).

If the parameter is within the operating limits, the method 800 may include (e.g., automatically) increasing performance of the component while staying within the operating limits, as at 810. For example, if the second parameter (e.g., velocity) of the component is 1 meter per second (m/s), and the operating limit is 2 m/s, then the performance of the component may be increased such that the velocity of the component becomes greater than 1 m/s but less than or equal to 2 m/s. In another embodiment, rather than automatically increasing performance of the component, the control system may notify an operator that the performance of the component may be increased, and the operator may decide whether to (e.g., manually) increase the performance of the component.

If the parameter is outside the operating limits, the method 800 may include (e.g., automatically) decreasing performance of the component to be within the operating limits, as at 812. In at least one embodiment, this may include shutting down at least a portion of the tubular handling system 300 and/or the component. In another embodiment, rather than automatically decreasing performance of the component, the control system may notify an operator that the performance of the component should be decreased, and the operator may decide whether to (e.g., manually) decrease the performance of the component and/or to perform a system check or maintenance.

Instead of, or in addition to, the portions of the method 800 occurring at 808, 810, and 812, the method 800 may include comparing one of the parameters measured/determined during a first actuation of the component with the corresponding parameter measured/determined during a second actuation of the component, as at 814. Thus, if the parameter during the first actuation is position, then the corresponding parameter is also position. If the parameter during the first actuation is velocity, then the corresponding parameter is also velocity. If the parameter during the first actuation is acceleration, then the corresponding parameter is also acceleration.

As used herein, an actuation of the component refers to or includes a movement of the component. This may include an axial/linear movement, an angular movement, or another type of movement. The first actuation may occur at a first time or during a first time period, and the second actuation may occur at a second time or during a second time period. The difference between the first and second times (or time periods) may be a day, a week, a month, a year, etc. Thus, it may be possible that a portion of the tubular handling system 300 (e.g., the component) degrades and does not perform as well at the second time as it did at the first time.

For example, the component may be a pneumatic cylinder that extends and retracts in a linear manner with a stroke length of 10 cm. In the example shown in Table 1 below, the cylinder may actuate more slowly during the second actuation (e.g., at the second time), which may be due to degradation (e.g., wear and friction). In other embodiments, the cylinder may actuate more quickly during the second actuation, which may be due to, for example, leakages resulting in hydraulic power delivery.

TABLE 1

| | | |
|---|---|---|
| | Position During | Position During |
| Time | First Actuation | Second Actuation |

| | | | | | |
|---|---|---|---|---|---|
| 0 | seconds | 0 | cm | 0 | cm |
| 1 | second | 4 | cm | 3 | cm |
| 2 | seconds | 10 | cm | 8 | cm |

The method 800 may also include determining a health and/or performance of the tubular handling system 300 (e.g., the component) based at least partially upon the comparison, as at 816. If one or more of the first parameter, the second parameter, and/or the third parameter vary (e.g., increase or decrease) from the first actuation to the second actuation, this may be an indication that the health and/or performance of the tubular handling system 300 (e.g., the component) has varied (e.g., increased or decreased). In this example, the health and/or performance has decreased.

For example, it may be seen that the first parameter (e.g., position) decreased from the first actuation to the second actuation. More particularly, at t=1 second, the position decreased from 4 cm to 3 cm, and at t=2 seconds, the position decreased from 10 cm to 8 cm. This may be an indication that the health and/or performance of the tubular handling system 300 (e.g., the component) has decreased (e.g., due to degradation, friction, and/or wear).

Similarly, it may be seen that the second parameter (e.g., velocity) decreased from the first actuation to the second actuation. More particularly, from t=0 seconds to t=1 second, the velocity decreased from 4 cm/s to 3 cm/s, and from t=1 second to t=2 seconds, the velocity decreased from 6 cm/s to 5 cm/s. This may also be an indication that the health and/or performance of the tubular handling system 300 (e.g., the component) has decreased (e.g., due to degradation, friction, and/or wear).

If one of the parameters increases from the first actuation to the second actuation, this may be an indication that the health and/or performance of the tubular handling system 300 (e.g., the component) has increased (e.g., due to maintenance or repair). However, this may also be an indication that the health and/or performance of the tubular handling system 300 (e.g., the component) has decreased (e.g., due to a loss of hydraulic fluid causing the component to move faster than desired). As such, further analysis may be conducted.

In a slightly different example, the reaction time of the component may be measured/determined to determine the time that it takes for the component to begin the actuation after the command to actuate is entered. For example, if the reaction time increases from the first actuation to the second actuation, this may this may be an indication that the health and/or performance of the tubular handling system 300 (e.g., the component) has varied (e.g., decreased due to friction and/or wear). The method 800 may also include performing an action when the health and/or performance are determined to be below a predetermined threshold, as at 818. The action may be or include decreasing performance of the component, as described above. In another embodiment, the action may be or include triggering an alarm to signal an operator to analyze the reason for the increase or decrease in performance. In another embodiment, the action may be or include stopping or shutting down the tubular handling system 300 (e.g., the component) to perform maintenance.

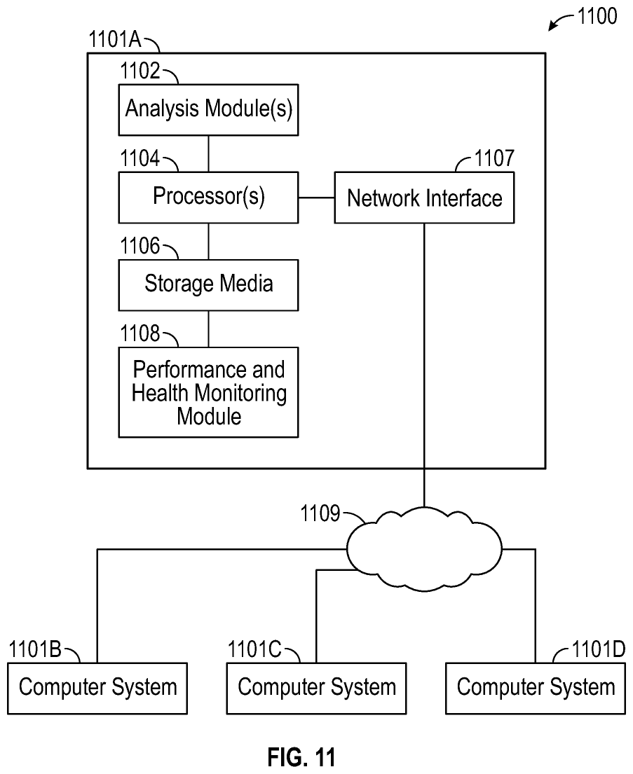

In some embodiments, the methods of the present disclosure may be executed by a computing system. FIG. 11 illustrates an example of such a computing system 1100, in accordance with some embodiments. The computing system 1100 may include a computer or computer system 1101A, which may be an individual computer system 1101A or an arrangement of distributed computer systems. The computer system 1101A includes one or more analysis modules 1102 that are configured to perform various tasks according to some embodiments, such as one or more methods disclosed herein. To perform these various tasks, the analysis module 1102 executes independently, or in coordination with, one or more processors 1104, which is (or are) connected to one or more storage media 1106. The processor(s) 1104 is (or are) also connected to a network interface 1107 to allow the computer system 1101A to communicate over a data network 1109 with one or more additional computer systems and/or computing systems, such as 1101B, 1101C, and/or 1101D (note that computer systems 1101B, 1101C and/or 1101D may or may not share the same architecture as computer system 1101A, and may be located in different physical locations, e.g., computer systems 1101A and 1101B may be located in a processing facility, while in communication with one or more computer systems such as 1101C and/or 1101D that are located in one or more data centers, and/or located in varying countries on different continents).

A processor may include a microprocessor, microcontroller, processor module or subsystem, programmable integrated circuit, programmable gate array, or another control or computing device.

The storage media 1106 may be implemented as one or more computer-readable or machine-readable storage media. Note that while in the example embodiment of FIG. 11 storage media 1106 is depicted as within computer system 1101A, in some embodiments, storage media 1106 may be distributed within and/or across multiple internal and/or external enclosures of computing system 1101A and/or additional computing systems. Storage media 1106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or alternatively, may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, the computing system 1100 contains one or more performance and health monitoring module(s) 1108. In the example of computing system 1100, computer system 1101A includes the performance and health monitoring module 1108. In some embodiments, a single performance and health monitoring module may be used to perform some or all aspects of one or more embodiments of the methods disclosed herein. In alternate embodiments, a plurality of performance and health monitoring modules may be used to perform some or all aspects of methods herein.

It should be appreciated that computing system 1100 is only one example of a computing system, and that computing system 1100 may have more or fewer components than shown, may combine additional components not depicted in the example embodiment of FIG. 11, and/or computing system 1100 may have a different configuration or arrangement of the components depicted in FIG. 11. The various components shown in FIG. 11 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to explain at least some of the principals of the disclosure and their practical applications, to thereby enable others skilled in the art to utilize the disclosed methods and systems and various embodiments with various modifications as are suited to the particular use contemplated.

What is claimed is:

1. A method for monitoring a component, comprising:
measuring a first parameter of the component of a tubular handling system using a sensor, wherein the component moves as the tubular handling system moves a tubular, and wherein the first parameter is related to movement of the component;
determining a second parameter of the component based at least partially upon the first parameter; and
determining whether the second parameter is within an operating limit.

2. The method of claim 1, wherein the first parameter comprises position, and wherein the second parameter comprises velocity.

3. The method of claim 1, wherein the first parameter comprises velocity, and wherein the second parameter comprises acceleration.

4. The method of claim 1, wherein the first parameter comprises acceleration, and wherein the second parameter comprises force.

5. The method of claim 1, further comprising determining a third parameter based at least partially upon the second parameter.

6. The method of claim 1, wherein measuring the first parameter comprises:
measuring the first parameter during a first actuation of the component that occurs at a first time or during a first time duration; and
measuring the first parameter during a second actuation of the component that occurs at a second time or during a second time duration.

7. The method of claim 1, further comprising increasing performance of the component when the second parameter is within the operating limit, wherein the performance is increased to a level that does not exceed the operating limit.

8. The method of claim 1, further comprising decreasing performance of the component when the second parameter exceeds the operating limit.

9. The method of claim 1, further comprising determining a reaction time of the first actuation, the second actuation or both.

10. A method for monitoring a component, comprising:
measuring a first parameter of the component using a sensor, wherein the first parameter is measured during a first actuation of the component that occurs at a first time or during a first time duration, and during a second actuation of the component that occurs at a second time or during a second time duration, and wherein the first time or the first time duration occurs before the second time or the second time duration;
determining a second parameter of the component based at least partially upon the first parameter, wherein the second parameter is determined during the first actuation and the second actuation; and
comparing the second parameter during the first actuation with the second parameter during the second actuation.

11. The method of claim 10, wherein the first parameter comprises position, and wherein the second parameter comprises velocity.

12. The method of claim 10, wherein the first parameter comprises velocity, and wherein the second parameter comprises acceleration.

13. The method of claim 10, wherein the first parameter comprises acceleration, and wherein the second parameter comprises force.

14. The method of claim 10, further comprising determining a third parameter based at least partially upon the second parameter.

15. The method of claim 10, further comprising determining that a health, a performance, or both of the component has decreased when the comparison shows that the second parameter decreased from the first actuation to the second actuation.

16. The method of claim 15, further comprising triggering an alarm, decreasing the performance of the component, or stopping the component in response to the determination that the second parameter has decreased.

17. The method of claim 10, further comprising determining that a health, a performance, or both of the component has decreased when the comparison shows that the second parameter increased from the first actuation to the second actuation.

18. The method of claim 17, wherein the second parameter increased in response to a loss of fluid.

19. A tubular handling system, comprising;
a component;
a sensor configured to measure a position of the component during a first actuation of the component and during a second actuation of the component, wherein the first actuation occurs at a first time or during a first time duration, and wherein the second actuation occurs at a second time or during a second time duration; and
a control system configured to:
receive the position of the component during the first actuation and the second actuation;
determine a velocity of the component based at least partially upon the position during the first actuation and the second actuation;
determine an acceleration of the component based at least partially upon the velocity during the first actuation and the second actuation;
determine whether the position, the velocity, and the acceleration are within operating limits during the first actuation and the second actuation; and
determine whether a health, a performance, or both of the component have decreased from the first actuation to the second actuation based at least partially upon the position, the velocity, the acceleration, or a combination thereof.

20. The system of claim 19, wherein the control system is further configured to determine that the health, the performance, or both have changed in response to the position, the velocity, the acceleration, or a combination thereof increasing from the first actuation to the second actuation.

21. The system of claim 19, wherein the position is received from a position sensor, and wherein the velocity and acceleration are determined without use of a velocity sensor or an acceleration sensor.
